(19) United States
(12) Patent Application Publication
(10) Pub. No.: US 2007/0118910 A1
(43) Pub. Date: May 24, 2007

(54) IDENTIFICATION OF FILES IN A FILE SHARING ENVIRONMENT

(76) Inventor: Stephen F. Taylor, Virginia Beach, VA (US)

Correspondence Address: STRATEGIC PATENTS P.C.., C/O PORTFOLIOIP, P.O. BOX 52050, MINNEAPOLIS, MN, 55402, US

(21) Appl. No.: 11/552,910

(22) Filed: Oct. 25, 2006

Related U.S. Application Data
(63) Continuation-in-part of application No. 11/470,244, filed on Sep. 5, 2006.
(60) Provisional application No. 60/730,229, filed on Oct. 25, 2005.
(60) Provisional application No. 60/733,961, filed on Nov. 4, 2005.
(60) Provisional application No. 60/733,962, filed on Nov. 4, 2005.
(60) Provisional application No. 60/714,102, filed on Sep. 2, 2005.
(60) Provisional application No. 60/726,726, filed on Oct. 14, 2005.

(51) Int. Cl. H04L 9/32

(52) U.S. Cl. 726/27

(57) ABSTRACT

The methods and systems disclosed herein support identification of video media in a file sharing and/or file distribution environment where both known media and unknown media are circulated. The identification techniques can be deployed in a variety of client and server configurations, and may use a centralized or global database to promulgate rules associated with various files once they are identified. Similar techniques may be employed for identification of executable software such as games, applications, and the like.

### RELATED APPLICATION

This application claims the benefit of the following commonly-owned U.S. Provisional Applications: U.S. app. No. 60/730,229 filed on Oct. 25, 2005; U.S. App. No. 60/733,961 filed on Nov. 4, 2005; and U.S. App. No. 60/733,962 filed on Nov. 4, 2005; and this application is a continuation-in-part of commonly-owned U.S. application Ser. No. 11/470,244 filed on Sep. 5, 2006, which further claims the benefit of U.S. App. No. 60/714,102 filed on Sep. 2, 2005 and U.S. App. No. 60/726,726 filed on Oct. 14, 2005. The contents of each of the foregoing applications is incorporated by reference in its entirety.

### BACKGROUND

As file sharing activity has grown, so has the proliferation of illegitimate file sharing activity such as the unauthorized distribution of media. Legitimate rights holders have developed a number of techniques to counter this trend including techniques aimed at disrupting file sharing networks (e.g., spoofing, queuing) and techniques aimed at controlling use of the underlying media (e.g., encryption, or more generally digital rights management).

While these techniques have enjoyed varying degrees of success, positive identification of video media remains an enduring challenge. In part this is due to the sheer size of video files, and in part, this is due to the computational complexity of current content-based identification algorithms. File sharing is also complicated where commercial content—that is content legitimately owned by a copyright or other rights holder and intended for sale—and non-commercial content are intermingled.

There remains a need for improved identification techniques for use in a distributed file sharing environment, as well as a need for network infrastructures, including client and server configurations, that implement these techniques in a manner suitable for commercial distribution and sharing of video media.

### SUMMARY

The methods and systems disclosed herein support identification of video media in a file sharing and/or file distribution environment where both known media and unknown media are circulated. The identification techniques can be deployed in a variety of client and server configurations, and may use a centralized or global database to promulgate rules associated with various files once they are identified. Similar techniques may be employed for identification of executable software such as games, applications, and the like.

In one aspect, a method disclosed herein include receiving a video file; detecting a scene within the video file, the scene including a contiguous group of related images; extracting audio data associated with the scene; applying an audio fingerprinting technique to the audio data to create an index; determining one or more usage rules for the video file; and storing the usage rules in a certificate accessible using the index. The one or more rules may include at least one trading rule and/or at least one sharing rule. The method may include extracting scene data from the video file, the scene data including at least one reference frame and a plurality of motion vectors. The method may include storing one or more of the at least one reference frame and the plurality of motion vectors in the certificate. Applying an audio fingerprinting technique may include invoking a remote fingerprinting service.

In another aspect, a method disclosed herein includes receiving an executable file; decompiling the executable file into a plurality of functions; serializing the plurality of functions as a signal indicative of the frequency of each function; applying a temporal fingerprinting technique to the signal to obtain an index; and storing a certificate including one or more usage rules for the executable file in a location accessible using the index. The temporal fingerprinting technique may include an audio printing technique, a frequency domain fingerprinting technique, and/or invoking a remote audio fingerprinting service. The one or more usage rules may include at least one purchasing rule and the method may include purchasing the executable file according to the at least one purchasing rule.

In another aspect, a method disclosed herein includes receiving a video file; detecting a scene within the video file; extracting audio data from the scene; extracting scene data from the scene, the scene data including a first reference image and a plurality of motion vectors; applying an audio fingerprinting technique to the audio data to obtain an index; retrieving a certificate using the index, the certificate including expected scene data for the video file; and comparing a first video rendered using some of the scene data to a second video rendered using some of the expected scene data. Retrieving a certificate may include retrieving the certificate from a remote database. The first video may be rendered using some of the expected scene data from the certificate. The second video may be rendered using some of the scene data from the video file. Comparing may include substituting one or more motion vectors from the scene data for one or more motion vectors from the expected scene data and calculating an error function for the result. Applying an audio fingerprinting technique may include invoking a remote audio fingerprinting service. The method may include authenticating the video file when the error function is below a predetermined threshold. The method may include transcoding the video file to a common format before detecting the scene.

In another aspect, a method disclosed herein includes receiving a video file; detecting a scene within the video file, the scene including a contiguous group of related images; extracting audio data for the scene; applying an audio fingerprinting technique to the audio date to obtain an index; and retrieving a certificate based upon the index, the certificate including one or more rules for use of the video file. Retrieving the certificate may include retrieving the certificate from a remote server. The one or more rules may include at least one sharing rule, at least one local access rule, and/or at least one purchasing rule. Applying an audio fingerprinting technique may include invoking a remote audio fingerprinting service. The certificate may include expected scene data, the expected scene data including at least one expected reference frame and a plurality of expected motion vectors. The method may include extracting scene data from the scene and authenticating the video file by comparing the scene data to the expected scene data. The method may include initiating a purchase of the video file.

In various embodiments, systems disclosed herein include means for performing steps associated with the methods described above. In other embodiments, computer program products embodied in a computer readable medium may include code that, when executing on one or more computers, perform the steps of the methods described above.

### BRIEF DESCRIPTION OF FIGURES

The systems and methods described herein may be understood by reference to the following figures:

FIG. 1 illustrates a file sharing network.

FIG. 2 shows a hybrid flow chart and block diagram providing a high-level illustration of identification and certification functions.

FIG. 3 is a flow chart of a video identification method.

FIG. 4 shows a process for identifying video content using an index.

FIG. 5 depicts a process for index and fingerprint creation.

FIG. 6 shows an MPEG-2 implementation of video file identification using motion vector substitution.

FIG. 7 shows a process for indexing and identifying non-video content such as an executable file.

FIG. 8 shows a try-before-you-buy video object that implements the indexing and identification techniques disclosed herein.

### DETAILED DESCRIPTION

The following description relates to techniques for identifying video files, and for using such identification in a file sharing infrastructure that supports both commercial and non-commercial file distribution along with digital rights management and other commercially-oriented file sharing features. As a significant advantage, the disclosed techniques are suitable for video identification in file sharing or distribution networks using current computer technologies, and can be deployed in a manner that permits the integration of new or unrecognized files. However, it will be understood that, while certain representative embodiments are described in detail, that the techniques disclosed herein may be usefully employed in any environment where identification of digital media can be usefully coupled with verification, use restrictions, and the like. For example, the techniques described herein may be employed for identification of executable files, and a variety of client/server arrangements may be used to support varying degrees of centralization and functionality. All such variations are intended to fall within the scope of this disclosure.

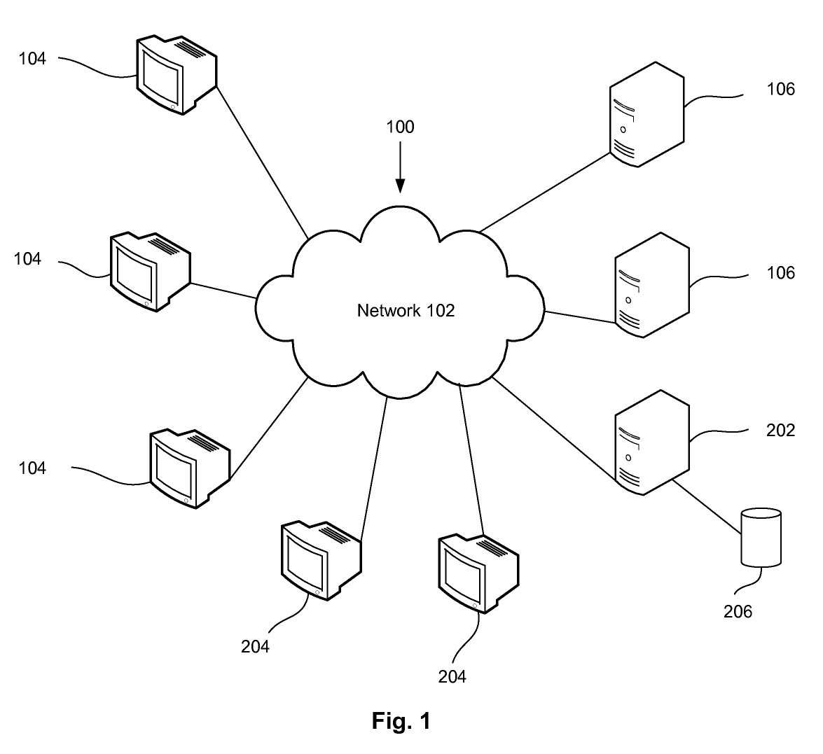

FIG. 1 shows a file sharing network that may be used with the systems and methods described herein. A file sharing network 100 may include a data network 102 interconnecting one or more participants 104 and one or more servers 106 for coordinating file sharing and exchanging media. While video sharing and distribution is discussed in detail herein, t will be appreciated that any number of different types of media may be transmitted in file sharing networks, including moving picture files (*.avi, *.mpg (which may include various Motion Picture Expert Group standards, such as MPEG-2 or MPEG-4), *.mov, *.asf, *.wmv, *.dvx, *.qt, and the like), Digital Versatile Disk files; HDDVD files, BlueRay files, sound files (*.wav, *.mp3, *.ra, *.ram, *.aiff, *.au, and the like) or Compact Disk files; pictures (*.jpg, *.bmp, *.png, *.tif, and the like). In addition to presentation-oriented video files or multimedia described above, the media may include documents for various application programs such as word processors (e.g., Microsoft Word or Correl WordPerfect), drafting programs (e.g., Visio), presentation programs (e.g., Microsoft PowerPoint), and Portable Document Format or other document management programs; as well as the applications themselves or other standalone executables including games, application software, operating system software, and so on. All such media may be shared through a file sharing or distribution network and are intended to fall within the meaning of the term “media” as used herein, unless specifically noted otherwise. Further, protected media may be any media in which an individual or entity has a proprietary interest, such as copyright rights, that provides lawful restrictions on use, copying, sale, or distribution thereof.

A number of file sharing networks 100 are known and widely used. In embodiments, such networks are either centralized, such as Napster, and employ one or more servers 106 to index content available for download from participants 104, or they are decentralized (with decentralized networks currently becoming much more popular). In a decentralized file sharing network 100 such as a peer-to-peer network, participants 104 share search functions and content provider functions. For example, one file sharing protocol, Gnutella, coined the phrase “servelet” to denote the combined server/client functionality of a participant in a Gnutella file sharing network. Other file sharing networks 100, such as KaZaa, BitTorrent, FastTack, Warez, mp2p, filetopia, Direct Connect, winMX, soulseek, and so on, use various combinations of distributed searching techniques, storage techniques, and transport methods. It should also be appreciated that a particular protocol may be employed for a number of wholly independent file sharing networks 100, such as the Multisource File Transfer Protocol, which is used in eMule, eDonkey, and Overnet. More generally, the file sharing network 100 may be any combination of protocols and technologies useful for sharing digital content among a number of users. It will be appreciated that new protocols, permutations of old protocols, and new applications using existing protocols appear frequently. Accordingly, the identification of particular file sharing and peer-to-peer networks here should in no way limit the scope of the methods and systems described herein.

The data network 102 may include any network or combination of networks for data communication, including but not limited to the Internet, the Public Switched Telephone Network, private networks, local area networks, wide area networks, metropolitan or campus area networks, wireless networks, cellular networks, and so on, as well as any combination of these and any other logical or physical networks that might be used with the same, such as virtual private networks formed over the Internet. More generally, the data network 102 may include any network or combination of networks suitable for forming data connections among devices and establishing a file sharing network 100 as described herein.

Each participant 104 may be any device connected to the data network 102 and participating in the file sharing network 100 described herein, including, for example, any computer, laptop, notebook, personal digital assistant, network-attached storage, cellular phone, media center, set-top box, or other device or combination of devices. In embodiments, a participant 104 may index, store, transmit, receive, and/or analyze media according to the protocol of the file sharing network 100. In one common configuration, a participant 104 will employ application software for participating in a particular file sharing network 100; however, other configurations are also possible, such as a web browser plug-in. Operation of participants 104 in a file sharing network 100 varies from network to network, and from protocol to protocol, and new protocols emerge regularly. As such, the following general description provides context only and in no way limits the meaning of file sharing networks 100 as they relate to the systems described herein.

Typically, participants 104 in a peer-to-peer network can form direct interconnections between locations identified by an Internet Protocol (IP) address or other address. A participant 104 may designate a path such as a file, directory, drive, or device for sharing or uploading local files and another path for storing or downloading remote files, which may be the same as or different from the shared file path. A participant 104 may include search software through which a user can enter queries which may be composed of any conventional search parameters including keywords, wildcards, Boolean operators, file characteristics (length, size, audio or video quality, compression ratio, etc.), connection characteristics (bandwidth, latency, duration of availability, users in queue for a particular file source or a particular file, data transfer rates for a participant 104, etc.), file metadata (author, album, length, owner, tracks, notices, hashes, etc.), and so on. Other participants 104 may receive the query and either forward the query to other participants 104 in the file sharing network 100 or search local files to determine whether responsive content is available, or both. Once responsive content has been located, a direct connection between a requesting participant 104 and the responding participant 104 through the data network 102 may be established to transfer content to the requester. A user interface may also be provided at the requesting participant 104 to monitor search and download status and, for example, to receive user inputs such as a selection of one or more out of many responding participants 104 from which a download will be initiated. It will be understood that each client 104 participating in the file sharing network 100 disclosed herein may locally execute software to perform the various client-side steps that will be described in greater detail below. All such techniques, as well as variations and combinations of the foregoing, may be employed for sharing files in the systems described herein.

One or more servers 106 may also be present in the file sharing network 100, depending on the particular file sharing technology in use. Prior to the emergence of peer-to-peer networks, file sharing typically occurred between users who would post to a searchable file transfer protocol (FTP) facility or news group that would store a copy of the shared content. In this context, the server 106 may be understood as a data repository or file server including some mass storage, one or more file distribution capabilities, and possibly a structured database or similar capability for locating files of interest on the server. More recently, centralized file sharing networks have used a server 106 to provide a centralized repository for indexes of content and locations, or simply IP addresses of participating nodes. For example, the popular BitTorrent protocol employs a “tracker”, which is a central server 106 that manages interconnections among participants 104 but carries no information about content being transferred among the participants 104. All such configurations, and combinations thereof, will be understood to fall within the scope of a server or media server as discussed herein. In other file sharing protocols, individual participants 104 provide an increasing amount of server-like functionality, including tracking the presence, quality, and content of neighboring participants 104 in the file sharing network 100. Participants 104 may even be enlisted in coordinating a download of a single media item from a number of different sources. Thus, it will be appreciated that participants 104 in many file sharing networks 100 may also be considered servers 106 with respect to their role in the network 100, and the use of the terms participant 104 and server 106 are both intended to encompass all such meanings unless another, specific meaning is clear from the context.

In addition to one or more clients 104 and optionally one or more servers 106, a certificate server 202 may maintain a global repository 206 of certificates, discussed in greater detail below, which may be accessed and distributed according to an index received from a client 104. In general, clients can derive an index from media such as video media, transmit the index to the certificate server 202 which retrieves a corresponding certificate from the global repository 206 and returns the certificate to the client 104. The certificate may contain, inter alia, sharing or usage rules for the media, as well as data for verifying the identification of the media. If the media is not recognized based upon the index, the server may proceed to index the media and provide default, temporary, or other usage rules for the unrecognized media. These and other aspects of the system will be described in greater detail below. It will be understood that while a single server 202 and repository 206 are depicted, any number of servers, which may be synchronized or unsynchronized, may be employed in the systems described herein, and the functionality of the server 202 may be distributed in a number of ways across a number of machines and/or geographic or network locations. It will be understood that the certificate server 202 and global repository 206 may locally execute software to perform various server-side steps described below.

In various embodiments, other participants 204 may belong to the file sharing network 100. This may include, for example, third party identification or rights management providers such as SnoCap and Phillips Content Identification, commercial rights owners, and media publishers or other providers. This may also, or instead, include a third party provider of contain claiming services such as Snocap's IDOL service. This may also, or instead, include financial transaction intermediaries including banks, credit card companies, electronic payment processors such as PayPal, and any other transaction or purchasing services or intermediaries. In general, these and other participants 204 may cooperate with the other network entities to support file sharing and distribution using the techniques described herein.

In certain embodiments, the client-side functions described herein may be realized as portable software that can be downloaded and, if necessary, installed on client devices. Such software may run in the background or in some other mode that is not intrusive into other uses of the client device 104, to perform related functions such as identifying and indexing video files present on the client device 104, or new video files received by the client device 104.

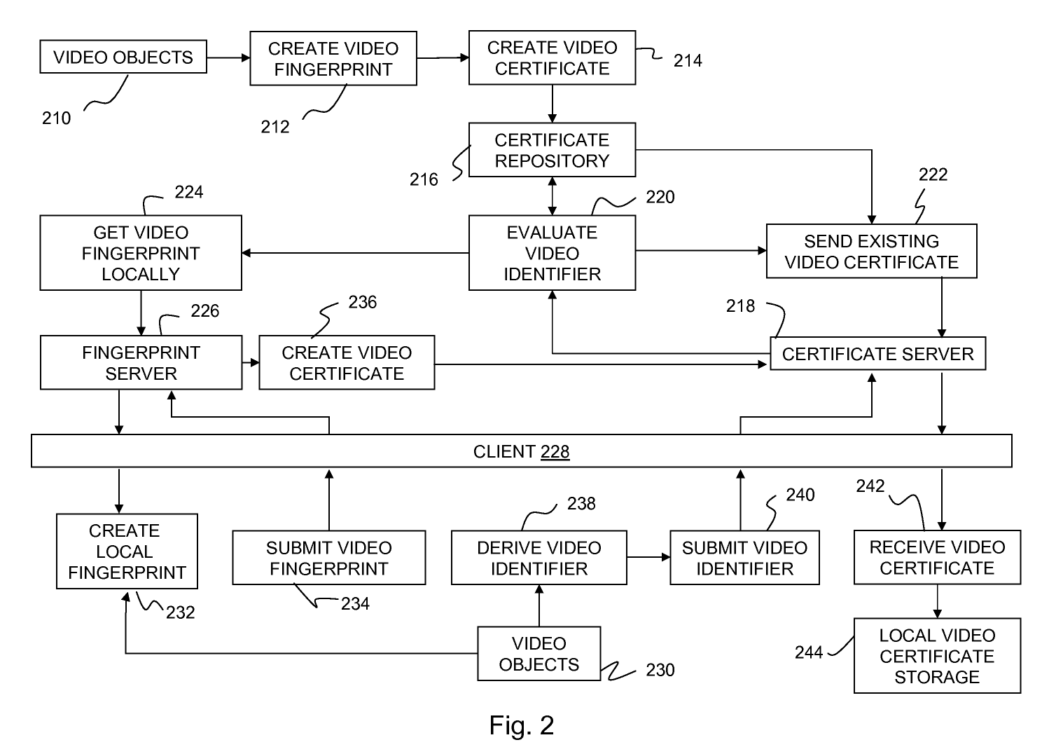

FIG. 2 shows a hybrid flow chart and block diagram providing a high-level illustration of identification and certification functions. In general, the flow chart illustrates server-side identification for the creation of a global certificate repository, as well as handling of new, unidentified video files by the client.

The process may begin by receiving one or more video objects 210, also referred to herein as video files, which may be processed to create a video fingerprint as shown in step 212 using fingerprinting techniques described in greater detail below. In one aspect, this step may include transcoding the video content to a common format (such as MPEG-2 or MPEG-4) to ensure meaningful comparisons of new video files. Video transcoding is well known in the art, and any suitable transcoding techniques may be employed with the systems and methods described herein. The resulting video fingerprint may in turn be employed to create a video certificate as shown in step 214, which may be stored in a certificate repository 216, which may be the global certificate repository 206 described above. In general, the certificate may include usage rules and/or data from the video files, such as scene data including one or more reference frames and one or more motion vectors. Usage rules may include trading or usage rules specified by a rights owner for the video file. Where the rights owner is unknown, the certificate may include default rules, or rules selected according to the client 228 that provided the fingerprint, or rules specified by the client 228 along with a new fingerprint and/or video file.

As depicted in FIG. 2, the certificate repository 216 may receive video identifiers from a certificate server 218 (which may be any of the servers described above) as shown in step 220, and may respond by providing certificates to the certificate server 218. As further illustrated in step 220, a video identifier from the server 218 may be evaluated in cooperation with the certificate repository 216 to determine whether a certificate exists for the corresponding video file 210. When the identifier is in the repository 216, the corresponding certificate may be provided to the server 218 as shown in step 222. When the identifier is not in the repository 216, the method may proceed to step 224 where a request is transmitted to a fingerprint server 226 to obtain an identifier from the client.

The fingerprint server 226 may forward a request to the client 228 to locally fingerprint a video file, and the client may respond by locally creating a fingerprint file from a local video file 230, as shown in step 232. In another aspect, the client 228 may independently submit a fingerprint to the fingerprint server 226, as shown in step 234, and the fingerprint server may create a corresponding certificate for transmission to the certificate server 218, as shown in step 236.

As a precursor to the request for local fingerprinting described above, or as a matter of ordinary processing of a newly obtained video file, the client 228 may derive a video identifier for a local video file 230 using a predetermined algorithm as shown in step 238. These algorithms are described in greater detail below. The identifier may be submitted to the certificate server 218 as shown in step 240, and the server may in response, evaluate the identifier as described above. This may result in a request to the client 228 to locally fingerprint the video file as previously described, or may result in the certificate server 218 returning a certificate to the client 228. In the latter aspect, the client 228 may receive the certificate as shown in step 242, and may store the certificate locally for client-side control of use and further distribution of the associated video file, as shown in step 244.

The certificate server 218, another server, may provide additional services. For example, the certificate server 218 may provide a programmatic interface to a purchasing system for initiating and/or clearing transactions to purchase video files residing with the file sharing network 100. The certificate server 218 may also, or instead, interface to a content claiming system so that, when an unidentified video file is detected, the file or representative data may be forwarded to the content claiming system for association with a rights owner for the file. The certificate server 218 may also interface with other third party services, such as the remote audio fingerprinting services discussed below. More generally, a number of useful and commercially available services may be usefully combined with the systems and methods described herein and all such combinations are intended to fall within the scope of this disclosure.

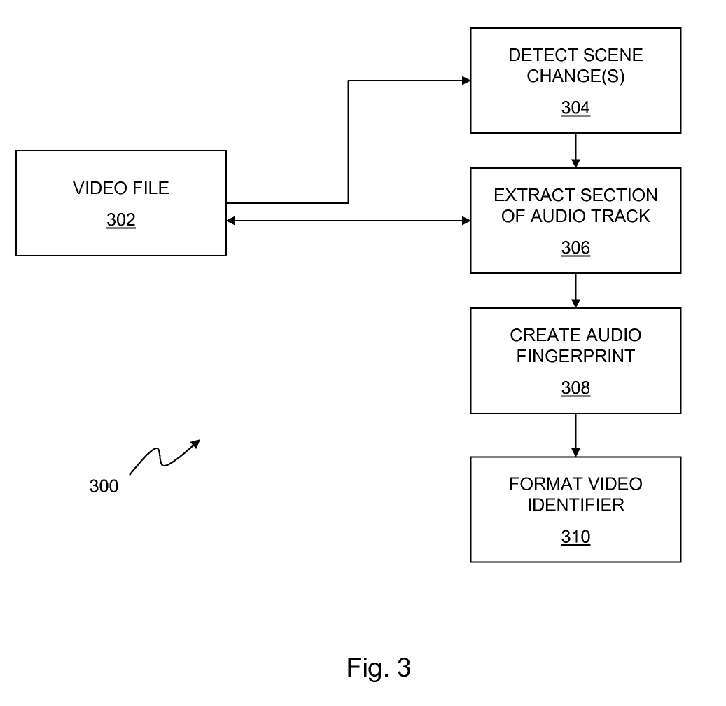

FIG. 3 is a flow chart of a video identification method. In general the method 300 is applied to a video file 302 to create an identifier for the file 302. It will be understood that the steps of this method 300 may be performed at a client, at a server, or both, as generally described above, according to the circumstances under which the identification is being performed, including the various steps described above with reference to FIG. 2, as well as variations to same and other deployments of the identification techniques described herein. Although not depicted, it will be understood that the video file may be transcoded into a common format as noted above, in order to facilitate comparisons in the identification system. In this context a transcoding step should be understood to include a possible non-operation where the video file is initially provided in the common format.

As shown in step 304, one or more scene changes may be detected within the video file. Any suitable techniques may be employed, and numerous techniques are known in the art. The beginning and end of a scene may be marked or identified using any suitable technique. In certain embodiments, one or more particular scenes in the video file may be selected for further processing using, for example, a selection negotiated between a client and server for each indexing/identification operation, or using a fixed selection (e.g., the second and fourth scenes for all video) for all indexing/identification.

As shown in step 306, an audio track containing audio data for the scene may be extracted from the video file. The relevant audio data may be identified using the scene beginning and end, as detected in step 304. This may include, for example, MPEG-1 audio layer three (commonly referred to as MP3) data, or any other audio data in any other format that is associated with the video file 302. The audio data may be transcoded into a common format if such a transformation has not already been performed for the video file that contains the audio data.

As shown in step 308, an audio fingerprint may be created. This fingerprinting may employ any suitable technique including compression, frequency domain transformation, hashing, or any other audio processing technique. In one embodiment, the audio fingerprinting may be performed by invoking a remote audio fingerprinting service. A number of such services are commercially available including, for example, Phillips Content Identification technology.

As shown in step 310, a video identifier, also referred to herein as an index, may be created using the audio fingerprinting results obtained in step 308. This may include a, for example a cryptographic has of the fingerprint to obtain a unique (or nearly unique) identifier for the fingerprint that may be used for subsequent storage and indexing operations.

It will be understood that while audio-based indexing is one useful technique that employs readily available tools, many other techniques may be employed for indexing content including techniques that employ content metadata, object attributes (where present), and so forth. All such techniques may be similarly employed to index video files with the systems described herein.

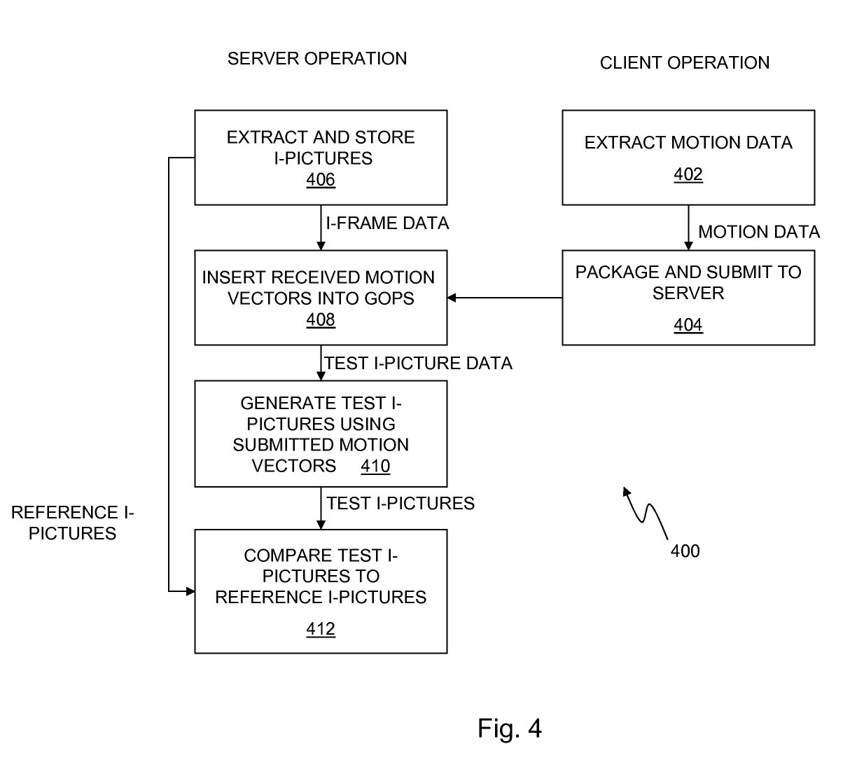

FIG. 4 shows a process for identifying video content using an index. In general the process 400 in FIG. 4 may be employed to authenticate a video file using motion vector substitution and comparison of the results.

Client operations in the process 400, depicted on the right hand side of FIG. 4, may begin with extracting motion data from a video file as shown in step 402. This may include, for example a plurality of motion vectors that encoded temporal changes in a series of video frames for one or more scenes of a video, such as used in the MPEG-2, MPEG-4, H.263, and H.264 video standards. Again, although not depicted, the client may transcode the video file into a common format before extracting motion data.

As shown in step 404, the motion data may be packaged and transmitted to a server, such as the certificate server described above.

As shown in step 406, the server may extract and store reference images from a source file. This may include, for example, reference I-pictures, I-frame data, or any other still images or other encoded form of reference data for motion-based video encoding, referred to generally herein as reference images. In addition, one or more subsequent frames of the video may be generated using the reference images of the source file in combination with motion data for the source video file, and stored as one or more test pictures for later use. In general, it is contemplated that this preprocessing step will be performed one time when the video is processed for use in the video identification systems described herein, although it may also be performed dynamically upon identification of a video by reference to its index.

As shown in step 408, the server may insert motion data from the client into a Group Of Pictures (“GOP”) that includes the reference images from the source video.

As shown in step 410, subsequent images in the video stream may be generated from a combination of expected scene data (from the reference images of the stored and indexed video) and actual scene data (motion data from the client-side video being identified). As shown in step 412, the resulting picture(s) may be compared to the test picture(s) created in step 406. The comparison may employ any suitable comparison techniques including a calculation of error functions or any other statistical comparison technique. A number of techniques are know for use in video analysis, and more particularly, for quantification of image differences, including block distortion tiling, blurring, jerkiness, noise, temporal edge noise, and so forth. These and other techniques may be usefully adapted for quantitative measurement of similarity between pictures.

In one aspect, a quantitative measure of similarity may be used in combination with a threshold to determine whether to authenticate or identify a client-side video file. That is, it is contemplated that some degree of variation may be present and acceptable, while greater degrees of variation will indicate a lack of identity. A threshold test may be employed to determine whether or not to identify a file as the file corresponding to an index. It will also be understood that a number of parameters may be varied and optimized according to the content being indexed and the deployment of the indexing system. For example, the threshold parameters may be varied, either manually or dynamically, and the number of frames (e.g., passage of video time) created before a comparison may be altered to relax or constrict the positive identification of candidate videos.

It will also be understood that numerous variations to the technique described above are possible. For example, motion vectors from the source file may be forwarded to the client for a client-side generation of test images based upon the client's version of the reference images. As another alternative, initial reference images immediately following a scene change may be directly compared to one another. All such techniques may be suitably employed with the systems described herein.

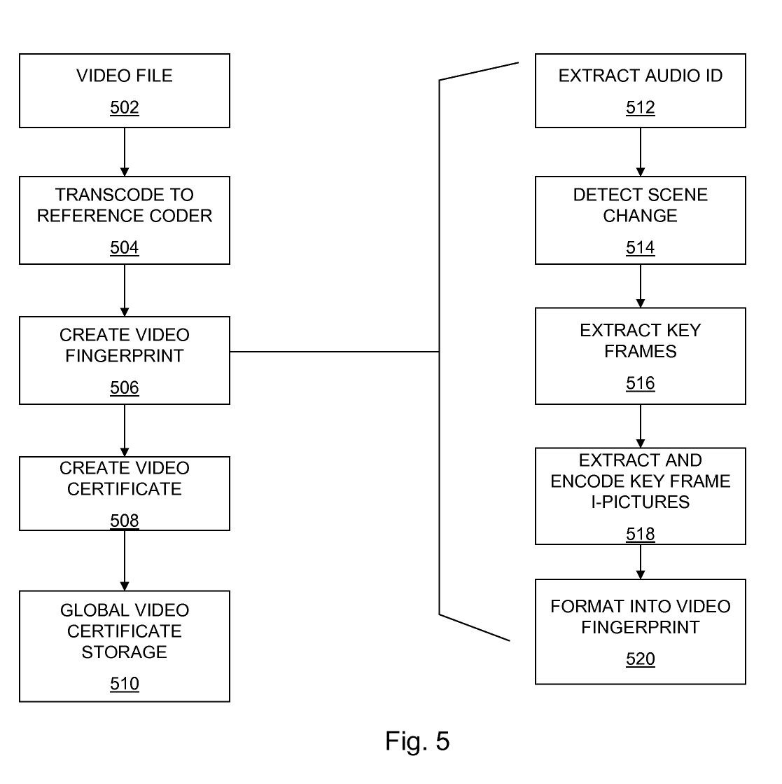

FIG. 5 depicts a process for index and fingerprint creation. In one variation to the fingerprinting techniques described above, audio data may be used to create an index for a video file, while selected scene data is used for fingerprinting.

The process 500 may begin by transcoding a video file 502 into a common format, as shown in step 504. A video fingerprint may then be created as shown in step 506, and discussed in greater detail below. A video certificate may then be create that combines the fingerprint and any appropriate usage rules for the video file 502, as shown in step 508. Finally, the certificate may be stored in a global certificate repository as shown in step 510.

The indexing and fingerprinting operations are detailed in steps 512-520. As shown in step 512, an audio index may be obtained based upon one or more scenes of the video file 502, as shown in step 512. This step has been described above. As shown in step 514, a scene change may be detected using, for example, scene detection techniques noted above. As shown in step 516, key frames may be extracted from the video file 502 at a suitable location, such as immediately following the scene change. As shown in step 518 key frame I-pictures may be extracted, from which suitable reference image data may be obtained. While suitable selection of key frames and corresponding reference data may vary according to particular video coding technologies, this will generally entail selection of reference still images or, where object-based encoding is used, a selection of prime objects. The reference data may be encoded and formatted into a fingerprint using any suitable fingerprinting algorithm including, without limitation, the fingerprinting algorithms described above.

Numerous variations are possible to the techniques described above. For example, where fingerprinting is performed based on reference images as described with reference to FIG. 5, a comparison method such as that described in reference to FIG. 4 may be employed. That is, the reference image may be contained in a certificate (or associated with the certificate), and applied to positively identify a candidate video file by using motion vectors from the candidate video file in combination with the reference image in the certificate to generate a test picture for comparison. In another aspect, motion data, such as a plurality of motion vectors, may be extracted from an indexed video file and include with the certificate (or associated with the certificate). In this case, one or more of the motion vectors from the candidate video may be directly correlated with one or more motion vectors in the certificate to obtain a similarity measure.

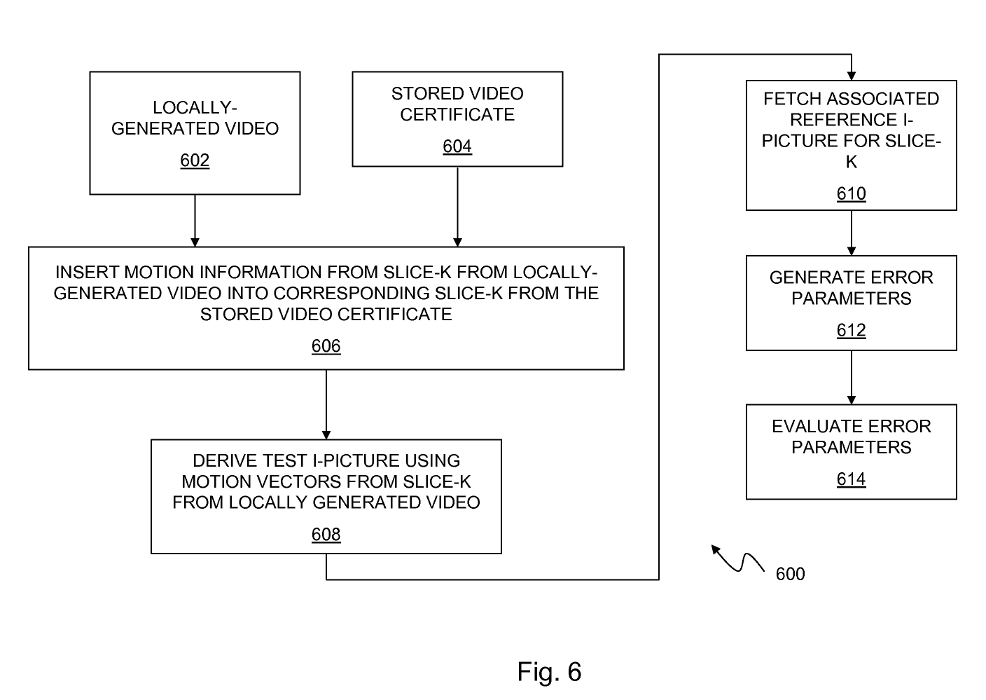

FIG. 6 shows an MPEG-2 implementation of video file identification using motion vector substitution. As shown in steps 602 and 604 respectively, an identification process 600 may begin with a local generation of video from an MPEG-2 source file, as shown in step 602, and the retrieval of a stored video certificate from a local or remote data source, as shown in step 604. One or more motion vectors from the locally generated video may be inserted into a slice of video data that includes an I-picture reference image from a slice of the corresponding scene data stored in the video certificate, as shown in step 606. As shown in step 608, a test picture may be derived by generating video from the certificate-based reference image and the local-file-based motion vectors. As shown in step 610 a reference I-picture may be fetched from the video certificate 604 (or associated storage) that corresponds to the point in time for the generated test picture.

As shown in step 612, the test picture (created with motion vectors from the “candidate” or local video file) and the reference picture (from the video certificate) may be compared to generate one or more error parameters. This may include, for example, any of the error or similarity measurements described above. In one embodiment, the error may be calculated as the residual noise of a difference image obtained by subtracting the reference picture from the test picture. In alternative embodiments, such as an MPEG-4 system using object-based encoding, other techniques may also, or instead, be employed, such as texture mapping or the like.

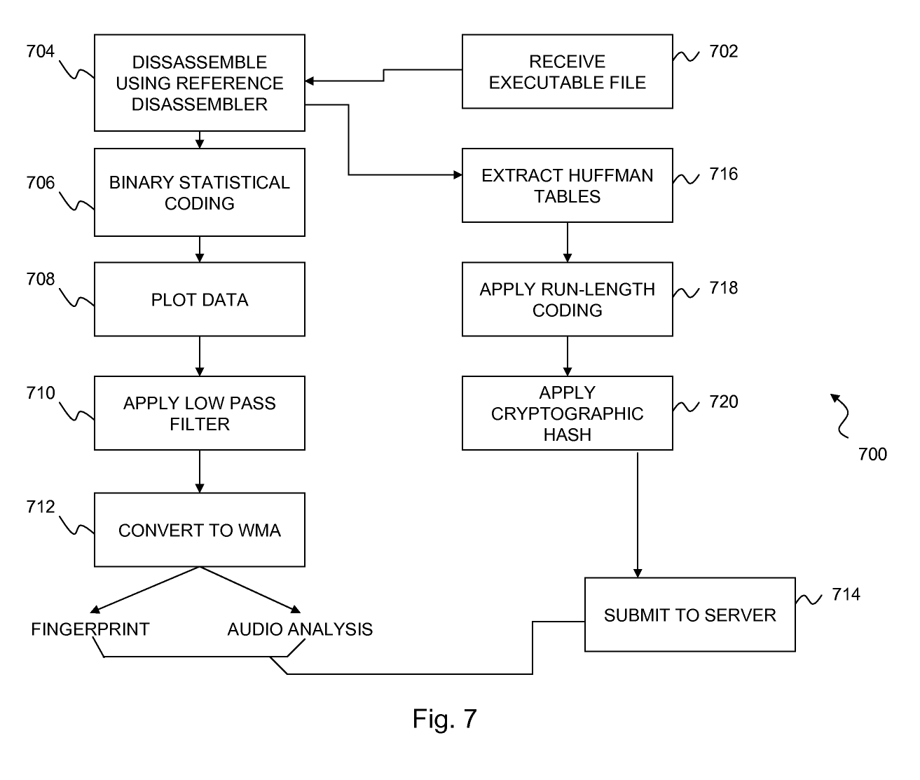

FIG. 7 shows a process for indexing and identifying non-video content such as an executable file. In general, the process 700 functions to disassemble and serialize the source program into a time based or quasi-time based representation that is amenable to fingerprinting and indexing using the techniques described herein. In the depicted embodiment, the serialized data is literally converted into a Windows Media Audio (“WMA”) file for direct use with audio fingerprinting techniques, however it will be understood that a variety of other audio formats are available, and that a variety of tools and techniques are know for directly manipulating a signal (even a quasi-time based signal such as the serialized frequency data obtained from the disassembly). All such techniques may be employed with the systems described herein.

As shown in step 702, an executable file may be received. As noted above, this may be a client-side operation performed for the purposes of obtain a certificate, for positively identifying the executable file, or for creating a new index/fingerprint for an executable file that is not recognized by the certificate server. On the other hand, this may be a server-side operation performed during a single or batch indexing function for new executables that are being added directly to the global certificate repository. The executable may be any type of executable file including by way of example and not limitation, documents (including text, rich text, HTML, XML, images, e-Books, word processing documents, spreadsheet documents, presentation documents, PDF documents, and so on), functional libraries, game software, operating system software, applications (including accounting software, financial management software, word processing software, spreadsheet software, web browser software, and so forth), hardware description language files and other circuit representations, computer automated design documents, and so forth. The executable file may be disassembled using a reference disassembler. A variety of disassemblers and disassembly techniques are known in the art and may be suitably employed with the systems described herein. A common reference disassembler may usefully be employed to ensure consistent results from indexing by different entities. The result of a typical disassembly process is a concatenation of functions that compose the source executable file.

Serialization of the disassembled data is now described in greater detail. As shown in step 706, binary statistical coding may be employed to encode functions of the disassembly result by frequency in variable-length binary format. As shown in step 708, the resulting binary codes may be plotted against frequency, or otherwise serialized to create a time based or quasi-time based signal. As shown in step 710, this time based signal may be further processed, such as through application of a low pass filter. While a low pass filter may usefully be employed to constrain the serialized signal to an audio band (e.g., 20 Hz-20 kHz), it will be understood that a variety of other techniques including band pass filters, windows, or any other filter may be employed. Similarly, it may be possible to employ simple scaling or other transformations to convert the serialized data into a form suitable for conversion into audio. As shown in step 712, the quasi-audio data may be converted into a common or reference format such as WMA. It will be understood that a variety of other audio encoding techniques exist and may be usefully employed in addition to, or instead of, WMA.

More generally, there are a wide variety of suitable processing options for the serialization and conversion to audio of disassembly results, and all such techniques that would be apparent to one of ordinary skill in the art are intended to fall within the scope of this disclosure. In general, the particular selection of serialization steps is less important than consistency and predictability of results. That is, for indexing and fingerprinting, the same file should produce the same results whether processed on any of a variety of potential servers or clients.

After an encoded audio file has been prepared, the file may be fingerprinted and indexed as described generally above. The resulting data may be submitted to a server for use in subsequent identification as shown in step 714.

An alternative approach to serialization of disassembly data is shown in step 716-720, which may be used instead of, in addition to, or in combination with the method of steps 706-712.

As shown in step 716, Huffman tables may be extracted directly from the concatenation of functions that form the disassembled executable file. These tables may in turn be run length coded as shown in step 718, and a cryptographic hash may be applied to the resulting data stream, as shown in step 720.

More generally, any serialization technique that yields a time-based or quasi-time-based signal from a disassembled executable may be usefully employed with the systems and methods described herein.

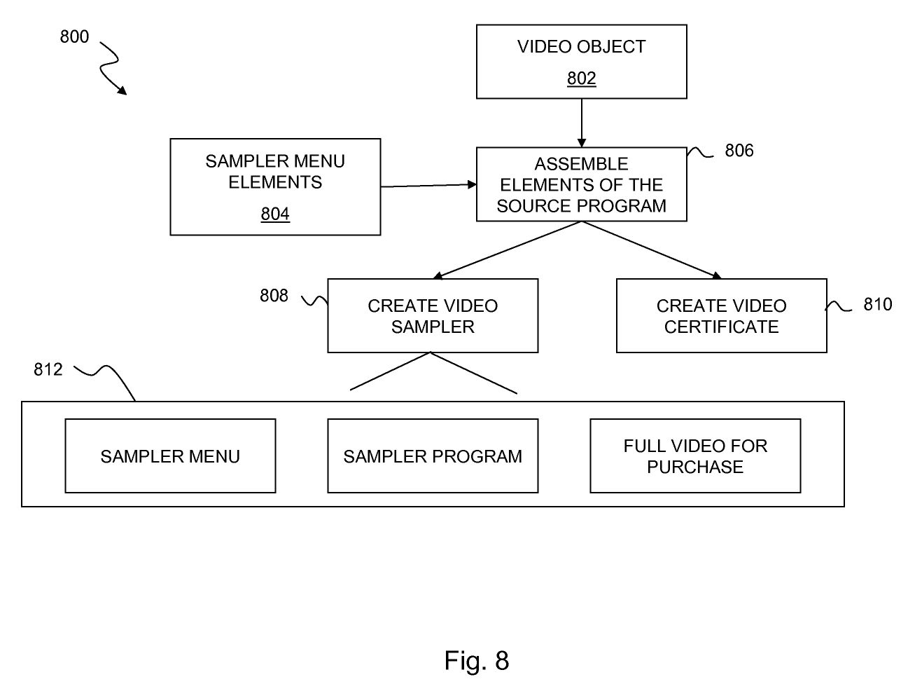

FIG. 8 shows a try-before-you-buy video object that implements the indexing and identification techniques disclosed herein.

As shown in step 806, the process 800 may begin by assembling elements of the video sampler, including a video object and a number of sampler menu elements 804. The samples menu elements 804 may specify aspects of a menu that appears to a user when the video object 802 is opened. This may include any number options such as one or more of: (a) play a trailer; (b) play excerpts of the video object; (c) play special features (e.g., director or actor interviews, deleted scenes, release information, alternate endings, and so forth); and/or (d) purchase video. Selecting option (d) will trigger a purchase mechanism that includes initiation and execution of a purchase transaction, and provision of any license, certificate, cryptographic key, or other items or permissions required to render the video. In an embodiment, this may include a modification to the usage rules associated with the user's local copy of a certificate for the video file.

As shown in step 808 a video sampler may be created, such as a degraded quality video segment from the video object 802, a voiced-over video segment, or some other representative but incomplete video file intended for unrestricted use.

As shown in step 810, a video certificate may be created using any combination of the techniques described above. The rights holder for the video object 802 may specify usage rules governing, e.g., local use, sharing, and purchase. The certificate may be forwarded to a global certificate repository as described generally above.

The sampler menu 804, the video sampler, and the video file 802 in full quality but disabled form may be combined into an object 812 that may be freely distributed. This may be provided, for example, in response to user requests for the file on the file sharing network 100 instead of an unrestricted copy of the video object 802. The video file 802 may be wrapped in any suitable digital rights management container. When a user opens the object 812, the sampler menu 804 will control use of the encapsulated content, and the full quality video.

It will be appreciated that the methods and procedures described above may be realized in hardware, software, or any combination of these suitable for the networking, content distribution and information management techniques described herein. The processes may be realized in one or more microprocessors, microcontrollers, embedded microcontrollers, programmable digital signal processors or other programmable device, along with internal and/or external memory. The processes may also, or instead, include an application specific integrated circuit, a programmable gate array, programmable array logic, or any other device that may be configured to process electronic signals. It will further be appreciated that the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across Nodes and other devices in a number of ways, or all of the functionality may be integrated into a single device. All such permutations and combinations are intended to fall within the scope of the present disclosure.

While the invention has been disclosed in connection with certain preferred embodiments, other embodiments will be recognized by those of ordinary skill in the art, and all such variations, modifications, and substitutions are intended to fall within the scope of this disclosure. Thus, the invention should not be limited to specific example embodiments provided above, but is to be interpreted in the broadest sense allowable by law.

1. A method comprising:
receiving a video file;
detecting a scene within the video file, the scene including a contiguous group of related images;
extracting audio data associated with the scene;
applying an audio fingerprinting technique to the audio data to create an index for the video file;
extracting a reference image from the scene;
applying a video fingerprinting technique to the reference image to create a fingerprint for the video file;
determining one or more usage rules for the video file; and
storing the usage rules and the fingerprint in a certificate accessible using the index.

2. The method of claim 1, wherein the one or more rules include at least one trading rule.

3. The method of claim 1, wherein the one or more rules includes at least one sharing rule.

4. The method of claim 1, further comprising transcoding the video file to a common format before detecting the scene.

5. The method of claim 1, further comprising extracting scene data from the video file, the scene data including at least one reference frame and a plurality of motion vectors.

6. The method of claim 5, further comprising storing one or more of the at least one reference frame and the plurality of motion vectors in the certificate.

7. The method of claim 1 wherein applying an audio fingerprinting technique includes invoking a remote fingerprinting service.

8. (canceled)

9. A method comprising:
receiving an executable file;
disassembling the executable file into a plurality of functions;
serializing the plurality of functions as a signal indicative of the frequency of each function;
applying a temporal fingerprinting technique to the signal to obtain an index; and
storing a certificate including one or more usage rules for the executable file in a location accessible using the index.

10. The method of claim 9, wherein the temporal fingerprinting technique includes an audio printing technique.

11. The method of claim 9, wherein the temporal fingerprinting technique includes a frequency domain fingerprinting technique.

12. The method of claim 9 wherein the one or more usage rules includes at least one purchasing rule, the method further comprising purchasing the executable file according to the at least one purchasing rule.

13. The method of claim 9 wherein applying a temporal fingerprinting technique includes invoking a remote audio fingerprinting service.

14. The method of claim 9 wherein serializing the plurality of functions includes converting the frequency data into an audio format.

15. (canceled)

16. A method comprising:
receiving a video file;
detecting a scene within the video file;
extracting audio data from the scene;
extracting scene data from the scene, the scene data including a first reference image and a plurality of motion vectors;
applying an audio fingerprinting technique to the audio data to obtain an index;
retrieving a certificate using the index, the certificate including expected scene data for the video file;
comparing a first video rendered using some of the scene data to a second video rendered using some of the expected scene data.

17. The method of claim 16 wherein retrieving a certificate includes retrieving the certificate from a remote database.

18. The method of claim 16 wherein the first video is rendered using some of the expected scene data from the certificate.

19. The method of claim 16 wherein the second video is rendered using some of the scene data from the video file.

20. The method of claim 16 wherein comparing includes correlating vectors for the first video and the second video.

21. The method of claim 16 wherein comparing includes substituting one or more motion vectors from the scene data for one or more motion vectors from the expected scene data and calculating an error function for the result.

22. The method of claim 21 further comprising authenticating the video file when the error function is below a predetermined threshold.

23-37. (canceled)
